(19) United States
(12) Patent Application Publication
(10) Pub. No.: US 2024/0125475 A1
(43) Pub. Date: Apr. 18, 2024

(54) SELF-EXTINGUISHING CANDLE

(71) Applicant: The Yankee Candle Company, Inc., South Deerfield, MA (US)

(72) Inventors: Qin Chen, Westerville, OH (US); John E. Cagle, Turners Falls, MA (US); Robert Earle Shave, Greenfield, MA (US); Herbert Samuel Dodson, China Grove, NC (US)

(21) Appl. No.: 18/547,844

(22) PCT Filed: Feb. 24, 2022
(86) PCT No.: PCT/US22/17602

§ 371 Date: Aug. 24, 2023

(51) Int. Cl. F23Q 25/00; F23D 3/16

(52) U.S. Cl. CPC F23Q 25/00; F23D 3/16

(57) ABSTRACT

A lid for a candle is provided. The lid comprises an inner housing which includes an inner housing aperture, as well as an iris including an iris guide section and at least two blades. The iris guide section has a respective blade guide slot for each of the at least two blades. Each of the at least two blades has opposing ends, and at least one bolt aperture at each of the opposing ends. A respective bolt extends through each at least one blade guide slot and each bolt aperture thereby engaging the at least two blades with the iris guide section. The iris has an open position and a closed position. In the open position, the inner housing aperture of the lid is open, and in the closed position, the blades of the iris extend over the inner housing aperture, thereby closing the inner housing aperture.

### FIELD OF INVENTION

The invention refers to containers. More specifically, the invention includes candle containers that are capable of automatically closing and extinguishing candle flames.

### BACKGROUND OF THE INVENTION

Candles are commonly used in households and are burnt for their fragrance, as decorative items, or for special occasions. However, a lit candle is an open flame and a potential fire hazard when not properly monitored. Accidental candle fires are responsible for approximately 4% of residential fires in the United States. Of those fires, about 36% occur due to inadequate supervision of candles, abandoned candles, or candles left unattended.

In order to reduce the safety risks caused by candles, manufacturers have invented self-extinguishing candles. There are generally three approaches to creating self-extinguishing candles: (1) chemically-treated or mechanically-engineered wicks to stop the candle from burning beyond a certain point; (2) use of auxiliary apparatuses, such as a fan, to blow out the candle flame; and (3) the use of auxiliary apparatuses, such as a snuffer, to cut off the air supply and extinguish the candle flame. While these approaches may be helpful in reducing accidental fires, the approaches may not be appropriate in many circumstances. Chemically-treated or mechanically-engineered wicks are difficult to manufacture and can negatively impact the burning of the candle, including fragrance release. The use of auxiliary apparatuses, such as a fan or snuffer, may negatively impact the aesthetic appeal of a candle and may also be a somewhat ineffective method of extinguishing the flame.

### BRIEF DESCRIPTION OF THE DRAWINGS

For a better understanding of the various embodiments of the present invention, reference may be made to the accompanying drawings in which:

FIG. 1 is a top perspective view of a self-extinguishing container with a lid in a closed position;

FIG. 2 is a top perspective view of the self-extinguishing container of FIG. 1 with the lid in an open position;

FIG. 3 is an exploded perspective view of the lid of FIGS. 1 and 2;

FIG. 4 is a top perspective view of a lid of FIGS. 1-3 in a closed position;

FIG. 5 is a bottom perspective view of the lid of FIGS. 1-4 in a partially open position;

FIG. 6 is a perspective view of an iris in an open position;

FIG. 7 is a perspective view of the iris of FIG. 7 in a closed position;

FIG. 8 is a top perspective view of a blade;

FIG. 9 is a perspective view of the series of blades of FIG. 7;

FIG. 10 is a perspective of the partially open iris of FIGS. 5 and 6;

FIG. 11 is a cross sectional view of the lid of FIG. 3 taken across line 4-4;

FIG. 12 is a top perspective view of the self-extinguishing container of FIGS. 1 and 2 with a power source; and

FIG. 13 is a perspective view of the lid of FIGS. 1-5 and a vessel.

While the disclosure is susceptible to various modifications and alternative forms, specific embodiments thereof are shown by way of example in the drawings and will herein be described in detail. It should be understood, however, that the drawings and detailed description presented herein are not intended to limit the disclosure to the particular embodiment disclosed, but on the contrary, the intention is to cover all modifications, equivalents, and alternatives falling within the spirit and scope of the present disclosure.

### DETAILED DESCRIPTION OF THE DRAWINGS

The invention will now be described with reference to the drawing figures, in which like reference numerals refer to like parts throughout. For purposes of clarity in illustrating the characteristics of the present invention, proportional relationships of the elements have not necessarily been maintained in the drawing figures.

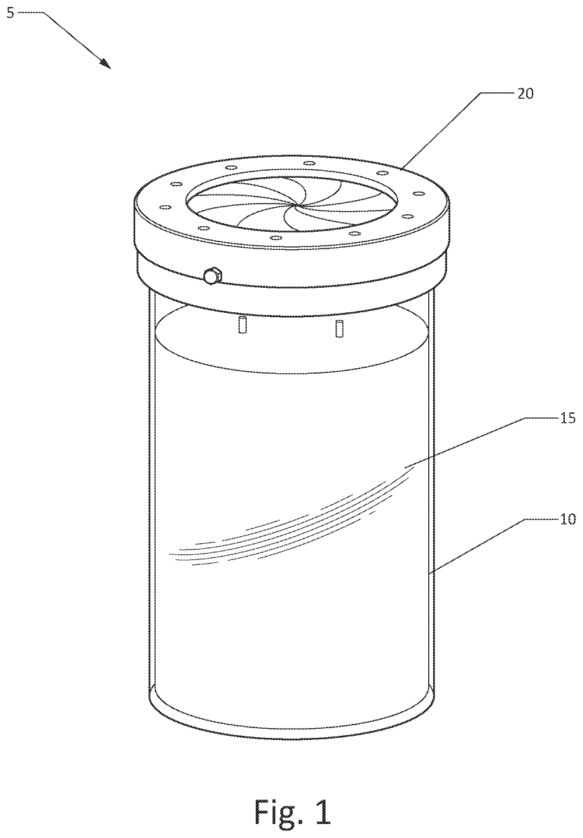

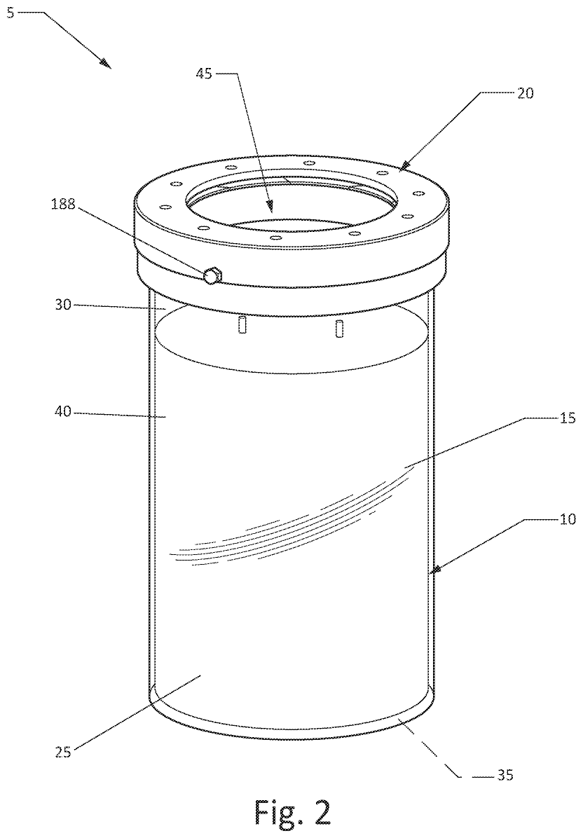

As illustrated in FIG. 1, a self-extinguishing container 5 includes a vessel 10, a substance 15, and a lid 20. Referring to FIG. 2, the vessel 10 includes a first end 25 and a second end 30. The vessel 10 further includes a base 35 located and positioned at the first end 25 of the vessel 10. The base 35 allows the vessel 10 to rest upon a table, counter, ledge, or some other surface. A sidewall 40 projects away from and extends around the perimeter of the base 35 towards the second end 30 to create a cavity 45 within the vessel 10. The first end 25 of the vessel 10 is therefore enclosed, while the second end 30 of the vessel 10 is open. In the illustrated embodiment of FIGS. 1 and 2, the vessel 10 is a hollow cylindrical member, with a circular cross section. In alternative embodiments, the cross section of the vessel 10 can be alternative shapes as well as sizes as long as the substance 15 may be placed within the cavity 45 as will be explained in more detail hereinafter.

The cavity 45 within the vessel 10 is preferably large enough that the substance 15 may be inserted into and through the open second end 30 of the vessel 10 so that the substance 15 is contained within the cavity 45. In one embodiment, the substance 15 may be candle wax. In alternative embodiments, the substance 15 may be oil, incense, other flammable and/or fragrance-emitting substance. The cavity 45 also preferably has a large enough diameter so that the heat may disperse, in embodiments where the container 5 is a candle, so that the container 5 is not dangerous to touch. The external surface temperature preferably should not exceed 175° F.

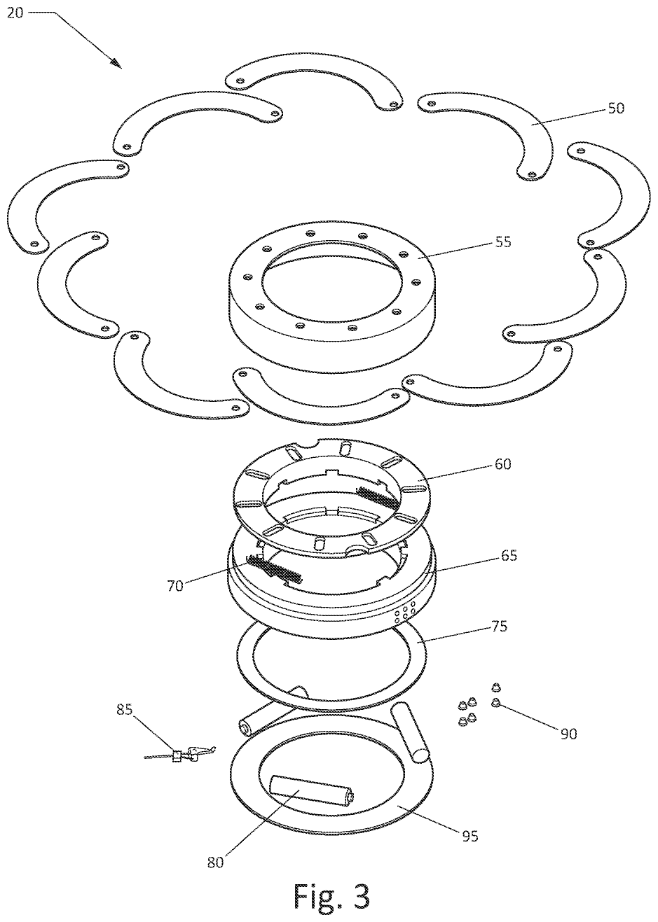

Turning to FIG. 3, the lid 20 of the self-extinguishing container 5 preferably has the same shape as the cross section of the vessel 10. However, the shape of the lid 20 may differ as long as the lid 20 is able to selectively engage with the vessel 10. The lid 20 may include a series of blades 50, an outer housing 55, a iris guide section 60, an inner housing 65, at least one spring 70, a printed circuit board 75, a power source 80, a latch 85, at least one indicator 90, and a bottom housing 95. The outer housing 55 is preferably shaped and sized so that the series of blades 50, the iris guide section 60, the inner housing 65, at least one spring 70, the printed circuit board 75, the power source 80, the latch 85, and at least one indicator 90 may all be placed and housed within the outer housing 55, as will be explained in more detail hereinafter. The bottom housing 95 may be sized and shaped so it fits within the bottom of the outer housing 55 to enclose the other components within the outer housing 55.

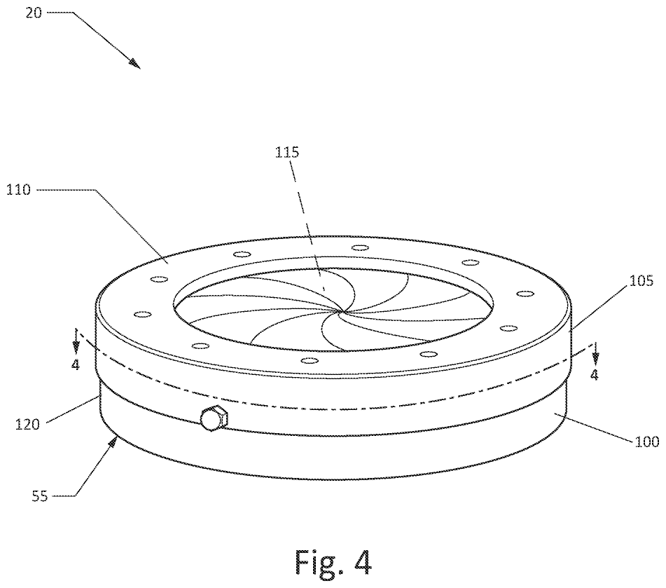

As shown in FIG. 4, the lid 20 has a first lid end 100 and a second lid end 105. The outer housing 55 of the lid 20 preferably has an outer housing top surface 110, which is preferably an annular ring. The outer housing top surface 110 therefore includes an outer surface housing aperture 115. The outer housing 55 also includes an outer housing sidewall 120 that extends around the circumference and projects away from the outer housing top surface 110 towards the first lid end 100.

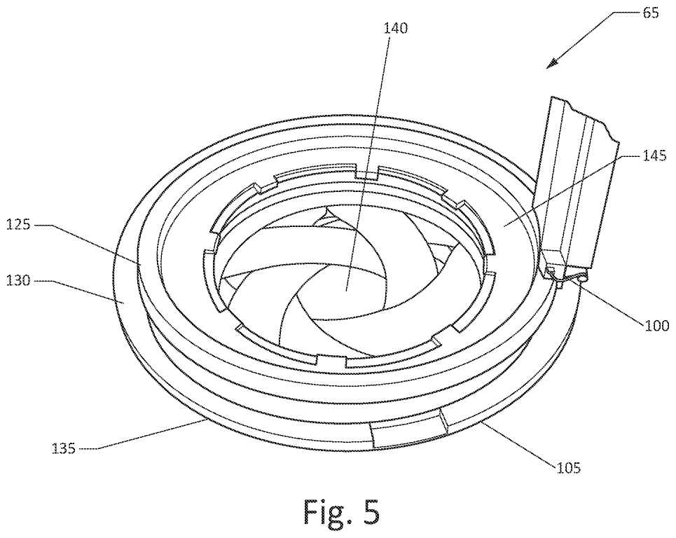

In the illustrated embodiment in FIG. 5, the inner housing 65 of the lid 20 includes a first inner housing section 125, a second inner housing section 130, and a third inner housing section 135. The first inner housing section 125 is located and positioned at the first lid end 100. The third inner housing section 135 is located and positioned at the second lid end 105, while the second inner housing section 130 is located and positioned in between the first inner housing section 125 and the third inner housing section 135.

The first inner housing section 125, the second inner housing section 130, and third inner housing section 135 are shown as annular rings, thereby creating an inner housing aperture 140. The outer circumference of the second inner housing section 130 may be larger than the outer circumferences of the first inner housing section 125 and the third inner housing section 135. The outer circumference of the first inner housing section 125 and third inner housing section 135 may be substantially the same.

The inner circumference of the first inner housing section 125 and the third inner housing section 135 may be substantially the same size, while the inner circumference of the second inner housing section 130 may be less than the inner circumference of the first and third inner housing sections 125, 135 and extends inwards to create a top inner housing ledge (not shown) and a bottom inner housing ledge 145. The shape and structure of the inner housing preferably allows the series of blades 50, the iris guide section 60, the at least one spring 70, the printed circuit board 75, the power source 80, and the latch 85 to be placed on top of the top inner housing ledge (not shown) and/or underneath the bottom inner housing edge 145. In alternative embodiments, the inner housing 65 may include a different number of sections, which may also be different shapes and sizes. Furthermore, not all of the aforementioned components must be located within the inner housing 65.

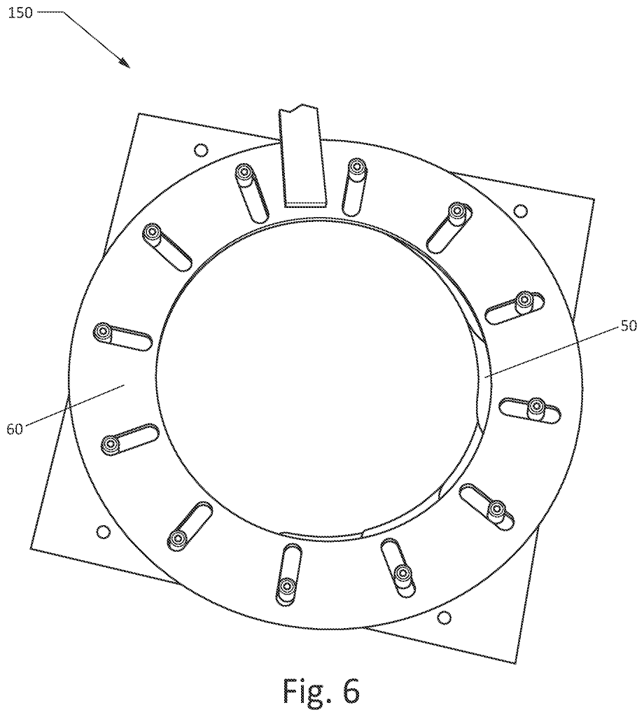

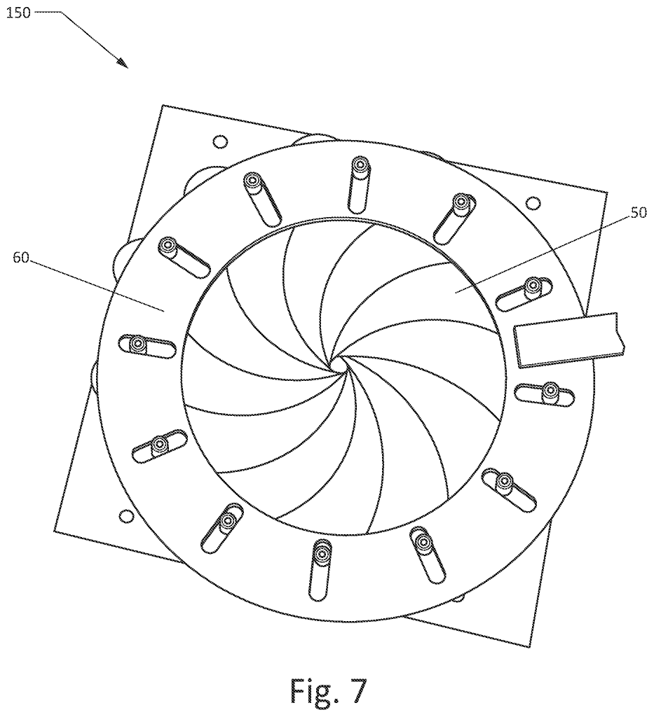

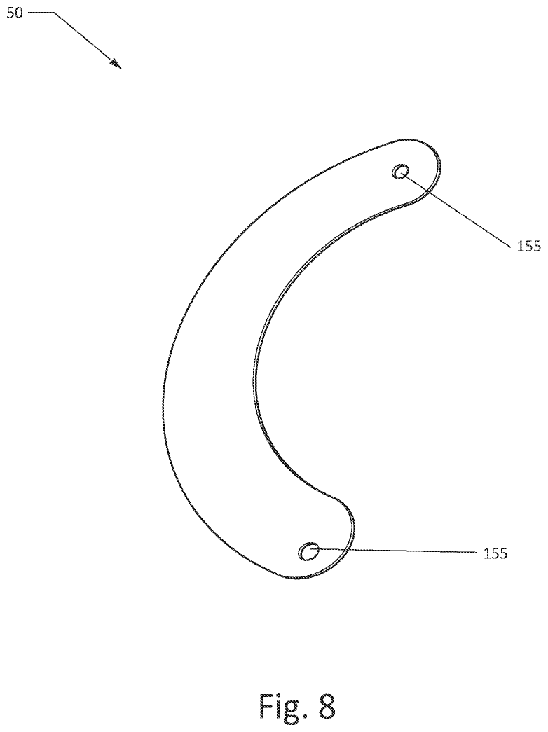

The lid 20 also includes an iris 150 located and positioned at the second lid end 105, within the inner housing aperture 140. Turning to FIGS. 6 and 7, the iris 150 is formed from a series of iris blades 50 (shown individually in FIG. 8) and an iris guide section 60. The iris blades 50 and iris guide section 60 allow the iris 150 to shift between an open position and a closed position, illustrated in FIGS. 6 and 7, respectively. The open position of the iris 150 allows a user to access the cavity 45 within the vessel 10. The open position of the iris 150 also allows for communication between the cavity 45 of the vessel 20 and atmosphere surrounding the self-extinguishing container 5. The closed position of the iris 150, however, closes the first end 25 of the vessel 10 and substantially blocks communication between the cavity 45 and the atmosphere around the self-extinguishing container 5.

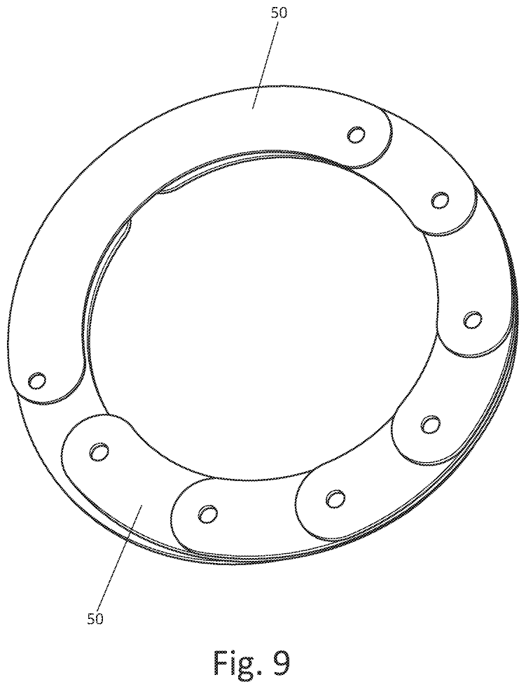

In the illustrated embodiment of FIG. 8, each blade 50 is a member preferably shaped like an elongated and curved oval. The blade 50 therefore has a C-like shape, and both ends of the blade 50 have a bolt aperture 155. The bolt aperture 155 is an aperture shaped and sized so that a bolt (known as bolt 160 hereinafter) may extend through the bolt aperture 155, as will be explained in more detail hereinafter. In alternative embodiments, the shape of the blade 50 may differ. As illustrated in FIGS. 6 and 9, the blades 50 are preferably arranged so that the series of blades 50 form a circle of blades 50 located and positioned adjacent to and abutting the iris guide section 60, which is preferably an annular ring. The iris guide section 60 preferably has substantially the same width as the blades 50. Although in alternative embodiments, the width of the iris guide section 60 can be more or less than the width of the blades 50.

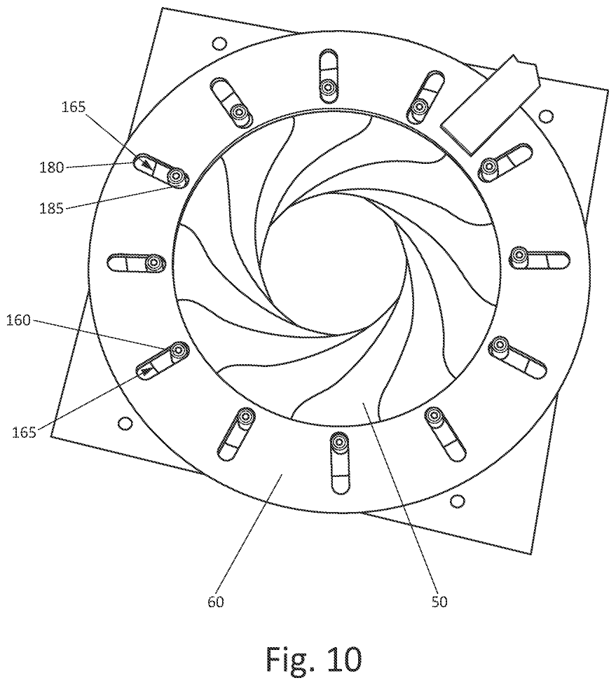

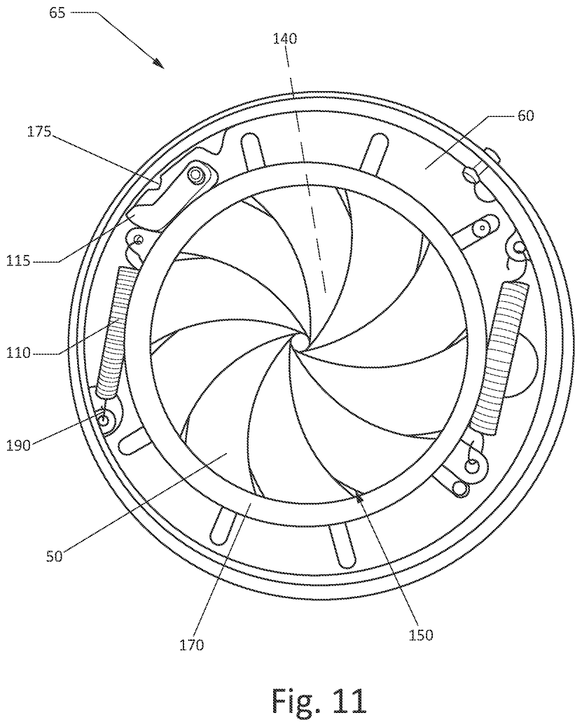

The iris guide section 60 includes a series of blade guide slots 165, as shown in FIG. 10. The series of blade guide slots 165 are preferably elongated oval apertures which extend radially outwards along the iris guide section 60. As shown in FIG. 11, the inner housing 65 further includes an inner iris guide section 170 that circumscribes and projects away from the inner circumference of the second inner housing section 130. The inner iris guide section 170 includes a notch 175 located and positioned at the rim 159 of the inner iris guide section 170.

Turning back to FIG. 10, the iris 150 also includes a series of bolts 160 for securing and guiding the movement of the blades 50. Each bolt 160 extends through a blade guide slot 165 of the iris guide section 60 and a bolt aperture 155 of the blade 50. Thus, both ends of the blade 50 are each secured to the iris guide section 60 by a bolt 160. The iris 150 is rotated or actuated so that the bolts 160 move along the blade guide slots 165 causing the blades 50 thereby moving the iris 150 into an open or close position. In an alternative embodiment, the blades 50 may not include bolt apertures 115. Instead, the bolts 160 may be integrally formed as part of the blades 50. The bolts 160 may also be glued, welded, or soldered onto the blade 50.

The iris 150 is in a closed position when the bolts 160 are located and positioned at an outer end 180 of the blade guide slots 165 within the third inner housing section 135. As the iris 150 is being opened, the bolts 160 move towards an inner end 185 of the blade guide slots 165. The blade guide slots 165 guide the bolts 160 so that the blades 95 move at the same speed and at the proper angle. The number of blades 50, as can the number of blade guide slots 165 and bolts 160, can vary due to the diameter of the cavity 45 of the lid 20. There can be any number of blades 50, blade guide slots 165, and bolts 160 as long as there are at least two blades 50, blade guide slots 165, and bolts 160.

As seen in FIG. 11, the movement of the blades 50 of the iris 150 may be further controlled by at least one spring 110, which may be a biasing spring 110, and at least one latch 115. The at least one spring 110 and at least one latch 115 may be used to move the iris 150 between an open and closed position. In one embodiment, the iris 150 is biased closed. When the iris 150 is to be opened, a user can manually rotate the iris guide section 60 (which is preferably engaged to the inner housing 65). As the iris guide section 60 is rotated, the bolts 160 slide within the blade guide slots 165 thereby causing the blades 50 to move until the iris 150 is in an open position. The rotation of the iris guide section 60 to move the iris 150 into its open position stretches or deforms the at least one spring 110. The iris guide section 60 is preferably rotated until the latch 115 is secured within the notch 175, which prevents the spring 110 from returning to its original shape which closes the iris 150.

In order to change the iris 150 to its closed position, the user can manually rotate the iris 150, wait until the self-extinguishing container 5 closes the iris 150 by itself, and/or use a reset button 188 (shown in FIG. 2). If the user rotates the iris guide section 60 in the opposite direction then to open the iris 150, the rotation causes the latch 115 to be pulled out of the notch 175. Once the latch 115 is pulled out of the notch 175, the springs 110 return to their normal shape which causes iris guide section 60 to rotate. As the iris guide section 60 rotates, the bolts 160 slide within blade guide slots 165 thereby causing the blades 95 to move until the iris 150 is in a closed position.

When the self-extinguishing container 5 closes the iris 150, an electrical signal can be sent along a muscle wire 190 which is connected to and engaged the latch 115. The electrical signal causes the muscle wire 190 to contract which pulls the latch 115 out of the notch 175. In alternative embodiments, the muscle wire 190 may be replaced with a solenoid or any other electrical to mechanical interface as known in the art. Once the latch 115 has been pulled out of the notch 175, the springs 110 actuate the iris guide section 60 so that the iris 150 rotates until is in its closed position, similar to as if the user had manually rotated the iris guide section 60. Thus, the iris 150 may be closed either manually or automatically by the self-extinguishing container 5 through electrical means. A controller, for example, may cause the release of the latch 115 after the occurrence of a predetermined condition, such as after a set amount of time, or after the candle burns down to a prescribed level, or the like.

The user may instead use the reset button 188 to close the iris 150. The reset button 188 may extend through the outer housing sidewall 120 as well as the inner housing 65. In one embodiment, the reset button 188 is located and positioned adjacent to the latch 115. When the reset button 188 is depressed by the user, the reset button 188 is pushed inwards where the reset button 188 mechanically pushes the latch 115 out of the notch 175. In an alternative embodiment, the reset button 188 may be located and positioned elsewhere, such that it is not directly adjacent to the latch 115. Instead, when the reset button 188 is depressed, the depressed reset button 188 may complete an electrical circuit causing the muscle wire 190 to contract thereby pulling the latch 115 out of the notch 175. Alternatively, additional mechanical linkages may connect the reset button 188 with the latch 115, allowing actuation of the reset button 188 to move the latch 115 out of the notch 175.

As with manually rotating the iris 150 and allowing the self-extinguishing container 5 to automatically close, in both reset button 188 embodiments, after the latch 115 has been removed from the notch 175, the springs 110 then return to their normal shape which causes iris guide section 60 to rotate. The blades 95 then move until the iris 150 is in a closed position. The iris 150 may therefore be closed through manual rotating the iris guide section 60, allowing the self-extinguishing container to automatically close after a set time, or actuating the closure of the iris 150 by pressing the reset button 188.

As shown in FIG. 3, the printed circuit board 75, or PCB, may also include resistors, controllers, and other electronic and data components that may be required to operate and/or control the self-extinguishing container 5. The PCB 75 may also be arranged within the inner housing 65. More specifically, the PCB 75 may be located and positioned within under the bottom inner housing edge 145 (shown in FIG. 5), or closer to the first end 100 as compared to the bottom inner housing edge 145. The PCB 75 is also in electrical and mechanical communication with the electronic and mechanical components used to operate the self-extinguishing container 5.

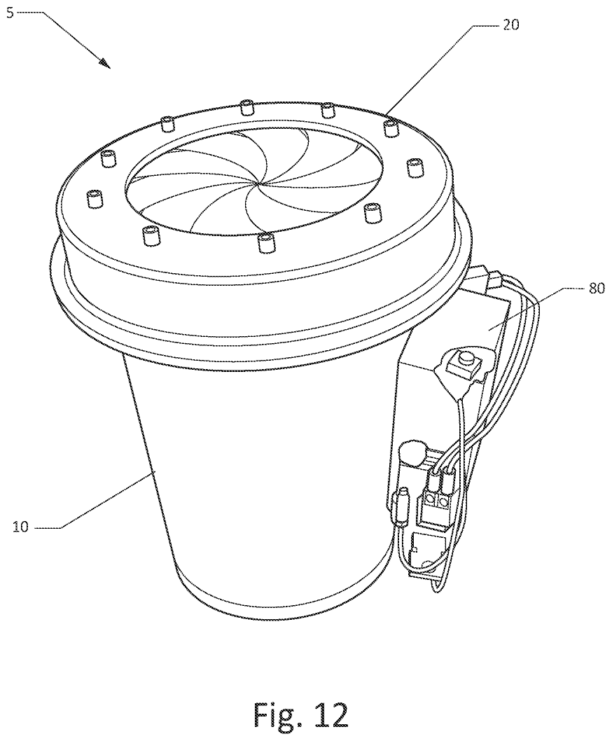

The PCB 75 may include or be in electrical and mechanical connection with a timing mechanism (not shown), which may send an electrical signal to the muscle wire 190 to close the iris 150 after a certain amount of time has passed or after a time set by the user. Alternatively, the user can send a signal to the PCB 75 for the PCB 75 to close the iris 150 through Wi-Fi, Bluetooth, and other communication methods as known in the art. The power source 80, shown in FIGS. 3 and 12, is mechanically and electrically connected to the PCB 75, allows the electric signal to be sent to the muscle wire 190. In one embodiment, the power source can be at least one battery, which may be located and positioned within the inner housing 65. In yet other embodiments, the power source can be solar power, hydroelectric, or plugged in a wall socket. The power source 80 may be located and positioned under both the bottom inner housing edge 145 and the PCB 75. However, in alterative embodiments, the power source 80 may be located elsewhere, such as on the side of the vessel 10, the top of the outer housing 55, or may just be connected to the self-extinguishing container 5.

The PCB 75 may also be in electronically communication to the at least one indicator 90, which may be embodied as an LED (light emitting diode) and shown in FIG. 3. The indicator 90 may also be a LED or liquid crystal display. The indicator 90 should also be in electronic communication with the power source 80. The at least one indicator 90 may signal to a user when the self-extinguishing container 5 has low power, sufficient power, if an amount of time has been set for the iris 150 to close, and/or how much time is left until the iris 150 closes. The at least one indicator 90 may be located on the outer housing 55. Thus, the power source 80 can provide power to the indicator 90, and the PCB 75 may read when the indicator 90 and iris 150 are being powered and/or when power should be provided to the indicator 90 and/or the iris 150.

In one embodiment, the iris 150, inner housing 65, PCB 75, and power source 80 can all be placed within the outer housing 55. The bottom housing 95 can then be placed so that it is adjacent to and abuts the outer housing 55 so that the various components of the self-extinguishing container 5 are secured within the outer housing 55 and the bottom housing 95. The iris guide section 60 is preferably adjacent to and engages the outer housing 55 so that when the outer housing 55 is rotated, the iris guide section 60 also rotates to open or close the iris 150.

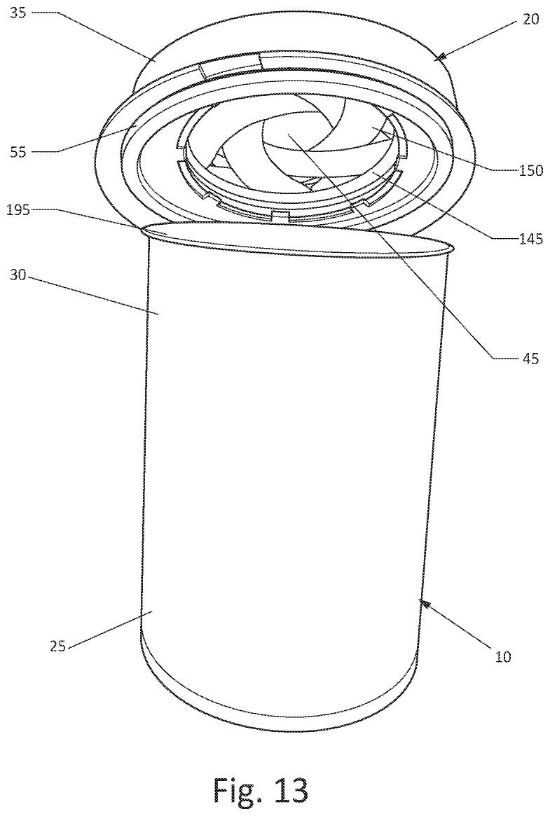

Referring to FIG. 13, the lid 20 may selectively engage the vessel 10 so that the bottom housing 95 is located and positioned adjacent to and abuts the second end 30 of the vessel 10. In greater detail, the lid 20 may be placed over the vessel 10 so that a rim 195 of the vessel 10 is adjacent to and abuts the bottom housing (not shown), or the bottom inner housing ledge 145 of the second inner housing section 130 in other embodiments, while the first inner housing section 55 circumscribes the second end 30 of the vessel 10 when the lid 20 and the vessel 10 are selectively engaged. In alternative embodiments, the lid 20 may have a different number of sections, or a different structure, as long as it is still able to engage the vessel 10. The lid 20 may also engage the vessel 10 through other methods, such as a threaded engagement or friction fit.

Therefore, in embodiments where the self-extinguishing container 5 is a candle, the user may remove the lid 20 to light the wick or rotate the outer housing 55 to open the iris 150 so that the user may access the cavity 45 to light the wick. The user may set a time either before or after lighting the candle, so that once a certain amount of time has passed, the iris 150 will automatically shut so that the iris 150 is in its closed position. Alternatively, the user may rotate the outer housing 55 (not shown) to close the iris 150. Once the iris 150 is closed, the iris 150 preferably prevents any or substantially all oxygen from entering the cavity 45. Therefore once the flame has used all the oxygen within the cavity 45, the flame will extinguish.

The self-extinguishing container 5 is preferably made out of materials that do not accumulate heat, preventing a user from getting burnt when touching the self-extinguishing container 5. The iris 150 may be made out of aluminum or tin-plated steel. However, in alternative embodiments, the iris 150 may be made out of different materials. The material of the self-extinguishing container 5 also preferably prevents substantial damage to the electronics within the lid 20 due to its materials and structure. The size of the cavity 45, inner housing aperture 140, and outer surface housing aperture 115 preferably have a large enough diameter so that heat is able to escape the vessel 10 without accumulating within the vessel 10.

From the foregoing, it will be seen that the various embodiments of the present invention are well adapted to attain all the objectives and advantages hereinabove set forth together with still other advantages which are obvious and which are inherent to the present structures. It will be understood that certain features and sub-combinations of the present embodiments are of utility and may be employed without reference to other features and sub-combinations. Since many possible embodiments of the present invention may be made without departing from the spirit and scope of the present invention, it is also to be understood that all disclosures herein set forth or illustrated in the accompanying drawings are to be interpreted as illustrative only and not limiting. The various constructions described above and illustrated in the drawings are presented by way of example only and are not intended to limit the concepts, principles and scope of the present invention.

Many changes, modifications, variations and other uses and applications of the present invention will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

What is claimed is:

1. A lid comprising:
an inner housing which includes an inner housing aperture;
an iris including an iris guide section and at least two blades;
the iris guide section having a respective blade guide slot for each of said at least two blades;
each of the at least two blades having opposing ends, and having at least one bolt aperture at each of the opposing ends;
a respective bolt extending through each at least one blade guide slot and each bolt aperture thereby engaging the at least two blades with the iris guide section;
the iris having an open position and a closed position, wherein:
in the open position, the inner housing aperture of the lid being open; and
in the closed position, the blades of the iris extending over the inner housing aperture thereby closing the inner housing aperture.

2. The lid of claim 1, wherein the inner housing further includes at least one spring and at least one muscle wire for triggering the closure of the ins.

3. The lid of claim 1, wherein the lid further includes a reset button for the closure of the iris.

4. The lid of claim 1, wherein at least one of the at least two blades being curved along its length.

5. The lid of claim 4, wherein movement of the bolts within the blade guide slots causes the iris to move from its closed to its open position, and vice versa.

6. The lid of claim 5, wherein rotation of the iris guide section causes movement of the bolts within the blade guide slots.

7. The lid of claim 1, further including a biasing spring to bias the iris guide section toward the closed position of the iris.

8. The lid of claim 7, wherein manual rotation of the iris guide section in a direction toward the open position of the iris opens the iris, and a latch secures the iris in the open position once reached.

9. The lid of claim 8, wherein release of the latch causes a biasing spring to move the iris to its closed position.

10. A self-extinguishing container system comprising:
a lid and a vessel;
the lid comprising:
an inner housing having an inner housing aperture;
an iris including an iris guide section and at least two blades;
the iris guide section having a respective blade guide slot for each of said at least two blades;
each of the at least two blades having opposing ends, and having at least one bolt aperture at each of the opposing ends of the blade;
a respective bolt extending through each at least one blade guide slot and each bolt aperture thereby engaging the at least two blades with the iris guide section;
the vessel comprising:
a base and a sidewall extending around the perimeter of the base and away from the base, thereby creating a cavity within the vessel;
wherein the lid and the vessel being selectively engageable with each other;
wherein the iris having an open position and a closed position, wherein:
in the open position, oxygen is able to enter the cavity of the vessel through the inner housing aperture of the lid; and
in the closed position, the blades of the iris extend over the inner housing aperture thereby substantially preventing oxygen from entering into the cavity.

11. The system of claim 10, wherein the inner housing further includes at least one spring and at least one muscle wire for triggering the closure of the iris.

12. The system of claim 10, wherein the lid further includes a reset button for the closure of the iris.

13. The system of claim 10, wherein at least one of the at least two blades being curved along its length.

14. The system of claim 13, wherein movement of the bolts within the blade guide slots causes the iris to move from its closed to its open position, and vice versa.

15. The system of claim 14, wherein rotation of the iris guide section causes movement of the bolts within the blade guide slots.

16. The system of claim 10, further including a biasing spring to bias the iris guide section toward the closed position of the iris.

17. The system of claim 16, wherein manual rotation of the iris guide section in a direction toward the open position of the iris opens the iris, and a latch secures the iris in the open position once reached.

18. The system of claim 17, wherein release of the latch causes a biasing spring to move the iris to its closed position.

19. The system of claim 18, wherein a controller causes the latch to release upon the occurrence of a predetermined condition.

20. The system of claim 18, wherein a muscle wire is engaged with the latch, and applying a current across the muscle wire causes the muscle wire to contract, thereby pulling and releasing the latch.
